(19) United States
(12) Patent Application Publication
(10) Pub. No.: US 2007/0126152 A1
(43) Pub. Date: Jun. 7, 2007

(54) Methods and apparatuses for reforming an upper portion of a blow molded plastic container

(75) Inventor: Brian J. Chisholm, York, PA (US)

Correspondence Address: VENABLE LLP, P.O. BOX 34385, WASHINGTON, DC, 20043-9998, US

(73) Assignee: GRAHAM PACKAGING COMPANY, L.P., York, PA (US)

(21) Appl. No.: 11/294,373

(22) Filed: Dec. 6, 2005

(51) Int. Cl. B29C 43/02

(52) U.S. Cl. 264/322; 425/394

(57) ABSTRACT

The present invention relates to a method of reforming an upper portion of a blow molded plastic container. The method comprising the steps of directing energy from a non-contact heater onto the upper portion to soften the upper portion, and compressing the upper portion between at least a first forming tool and a second forming tool to reform the upper portion. A plastic container, as well as an apparatus for reforming an upper portion of a blow molded plastic container, are also disclosed.

### BACKGROUND OF THE INVENTION

1. Field of the Invention

The present invention relates generally to plastic containers. More specifically, the present invention relates to methods and apparatuses for reforming the upper portion of a plastic container, and particularly, a blow molded plastic container.

2. Related Art

Capping processes for plastic containers typically require the upper portion of the container, such as the neck finish, to meet exacting dimensional tolerances. To achieve the necessary tolerances, the upper portions of containers are typically produced using injection molding processes, for example, by injection blow molding the containers. However, injection blow molding processes are at a significant output-to-cavity disadvantage when compared to other types of blow molding, such as extrusion blow molding. In addition, injection blow molding often requires expensive injection manifolds and involves sensitive injection processes.

According to another method of making containers, a preform with a pre-configured upper portion (e.g., neck finish) is made by injection molding. Subsequently, a container is blow molded from the lower portion of the preform. However, the upper portion can become distorted during blow molding due to the heat applied to the preform. This can cause the pre-configured upper portion to fall out of tolerance.

Furthermore, in order to achieve desirable tolerance levels using conventional extrusion blow molding technology, the containers typically have to undergo some type of cutting, stamping, and/or trimming operation. However, these operations have not proven to be reliable for producing the required dimensional tolerances.

Therefore, there remains a need in the art for improved methods, apparatuses, and containers that overcome the shortcomings of conventional solutions.

### BRIEF SUMMARY OF THE INVENTION

According to one exemplary embodiment, the present invention relates to a method of reforming an upper portion of a blow molded plastic container. The method comprising the steps of directing energy from a non-contact heater onto the upper portion to soften the upper portion, and compressing the upper portion between at least a first forming tool and a second forming tool to reform the upper portion.

According to another exemplary embodiment, the present invention relates to a blow molded plastic container having a upper portion with a flange reformed in accordance with the aforementioned method.

According to yet another exemplary embodiment, the present invention relates to an apparatus for reforming an upper portion of a blow molded plastic container. The apparatus comprises a non-contact heat source adapted to heat the upper portion of the plastic container, and first and second reforming tools spaced apart from the heat source. The first and second reforming tools are adapted to compress the heated upper portion between the first and second reforming tools to reform the upper portion.

Further objectives and advantages, as well as the structure and function of preferred embodiments will become apparent from a consideration of the description, drawings, and examples.

### BRIEF DESCRIPTION OF THE DRAWINGS

The foregoing and other features and advantages of the invention will be apparent from the following, more particular description of a preferred embodiment of the invention, as illustrated in the accompanying drawings wherein like reference numbers generally indicate identical, functionally similar, and/or structurally similar elements.

FIG. 1 is a schematic representation of the step of heating an upper portion of a container according to an exemplary embodiment of the present invention;

FIG. 2 is a schematic representation of the step of compressing the upper portion of the container between two forming tools according to an exemplary embodiment of the present invention;

FIG. 3 is an enlarged fragmentary view of the portion of FIG. 2 within the area A, prior to completion of the compressing step;

FIG. 4 is an enlarged fragmentary view of the portion of FIG. 2 within the area A, upon completion of the compressing step; and

FIG. 5 is side view of a plastic container according to an exemplary embodiment of the present invention.

### DETAILED DESCRIPTION OF THE INVENTION

Embodiments of the invention are discussed in detail below. In describing embodiments, specific terminology is employed for the sake of clarity. However, the invention is not intended to be limited to the specific terminology so selected. While specific exemplary embodiments are discussed, it should be understood that this is done for illustration purposes only. A person skilled in the relevant art will recognize that other components and configurations can be used without departing from the spirit and scope of the invention. All references cited herein are incorporated by reference as if each had been individually incorporated.

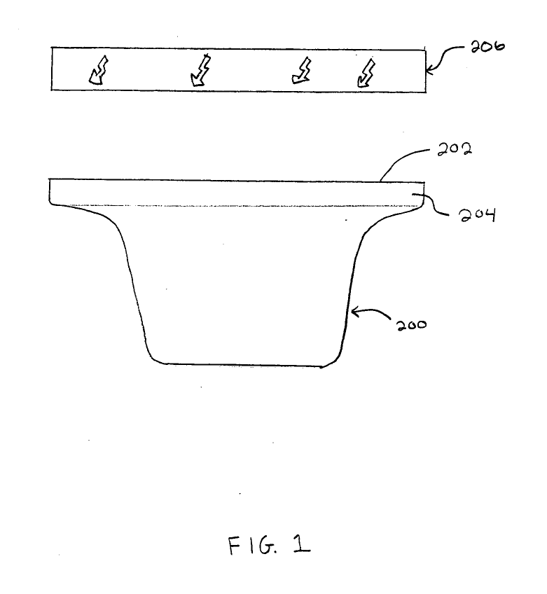

FIGS. 1-4 depict an exemplary method and apparatus according to the present invention. Referring to FIG. 1, plastic container 200 includes an upper portion 202. In the exemplary embodiment shown, plastic container 200 is in the shape of a bowl, for example, a soup bowl, and the upper portion 202 includes a substantially annular, outwardly-extending flange 204. Flange 204 can be adapted and configured to receive a closure, such as a metal lid, a layer of film (e.g., thermo-sealed or glued film), a snap-on lid, or a double-seam metal lid, although other configurations are possible. One of ordinary skill in the art will know and appreciate that plastic container 200 and/or upper portion 202 can take other forms. For example, plastic container 200 may alternatively be a beverage container, and upper portion 202 may alternatively include a threaded neck finish, or feature other geometries for sealing applications.

The upper portion 202 is typically formed during the blow molding of container 200, for example, during extrusion blow molding. The upper portion 202 may additionally or alternatively be formed, or modified, during a trimming or other operation that takes place, for example, after the container is blow molded. Alternatively, the upper portion 202 may be formed in connection with an injection or compression molding process, for example, on containers made using a reheat blow molding process or an injection/extrusion/blow molding process. Alternatively, the upper portion 202 may be formed in connection with an injection molded preform, in which the upper portion 202 is preconfigured during injection molding of the preform.

The present invention provides a method and apparatus that reforms the upper portion 202, for example, to provide the shape and dimensional tolerances required for the capping and/or sealing process. The method includes softening the upper portion 202, for example, by heating it with a non-contact heater 206. By “non-contact” is meant that the energy from non-contact heater is transferred to the upper portion 202 by radiation, convection, or other methods that don't involve physical contact with the upper portion 202. Heater 206 can comprise an infrared heater, a radiant heater, a quartz lamp, focused light energy, or a heated forming tool. One of ordinary skill in the art will know and appreciate that other “non-contact” techniques are available for softening upper portion 202. For example, energy from a laser or other focused light may be used to soften upper portion 202. Heater 206 may be adapted and configured to focus the heating energy onto the upper portion 202, for example, to heat flange 204 to its softening temperature, while leaving the remainder of container 200 relatively unheated.

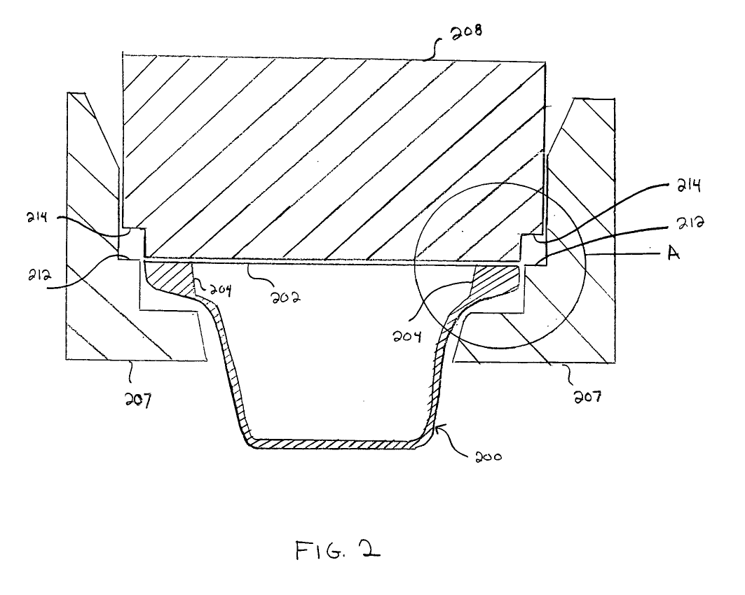

Once the upper portion 202 of container 200 is softened, two or more forming tools can be used to reform the upper portion 202. Referring to the exemplary embodiment of FIG. 2, a first forming tool 207 and a second forming tool 208 can be used to reform the upper portion 202, and more specifically, the flange 204. According to one exemplary embodiment, the first and second forming tools 207, 208 are constructed of metal, such as bronze, stainless steel, or aluminum, although other materials can alternatively be used.

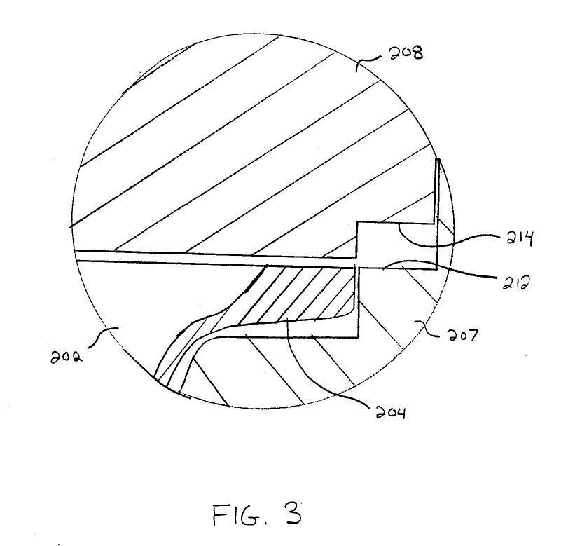

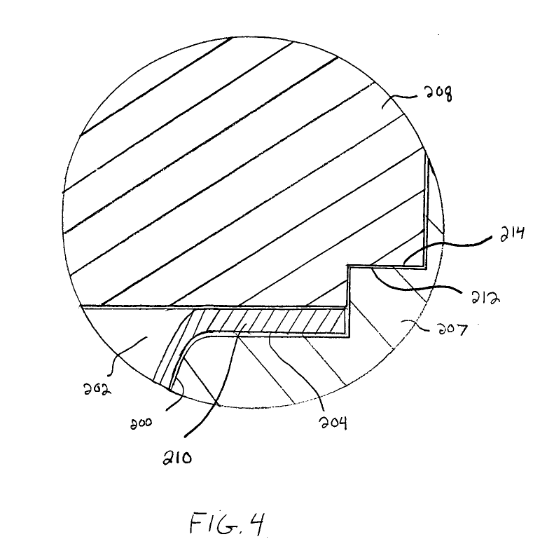

In the exemplary embodiment shown in FIG. 2, the forming tools 207, 208 are substantially opposed to one another, and can be moved from the position shown in FIGS. 2 and 3 to the position shown in FIG. 4, thereby compressing and reforming the upper portion 202. When in the position shown in FIG. 4 (i.e., the “closed position”), the first forming tool 207 and the second forming tool 208 mate to define a cavity 210 in which the upper portion 202 (e.g., the flange 204) is reformed to the desired shape and size. The first and second forming tools 207, 208 can include cooperating surfaces that engage one another (when the forming tools are in the closed position) to orient the forming tools 207, 208 with respect to one another and to maintain the cavity 210 at the intended shape and size. For example, first forming tool 207 can include a first engagement surface 212 and second forming tool 208 can include a corresponding second engagement surface 214. The amount of pressure applied by the first and/or second forming tools 207, 208 to move them to the closed position shown in FIG. 4, and the amount of time the forming tools 207, 208 are held in the closed position, can be adjusted empirically to obtain the desired geometrical, dimensional, and surface finish characteristics for the upper portion 202. A spring and cam system can be used to control the movement and pressure of the first and second forming tools 207, 208. Alternatively, hydraulic or pneumatic means can be used to control the forming tools.

Still referring to FIGS. 2-4, the first forming tool 207 can extend around the periphery of the upper portion 202. For example, first forming tool 207 can comprise a ring-shaped portion have an aperture corresponding in shape and size (e.g., diameter) to the upper portion 202 of container 200, allowing the container 200 to extend therethrough. According to an alternative embodiment, first forming tool 207 can have a recess or depression that corresponds in shape and size of the entire container 200. As shown in FIGS. 2-4, the second forming tool 208 can approach the container 200 from above, and compress the upper portion 202 downward and against the first forming tool 207, although other configurations of the first and second forming tools 207, 208 are possible.

While the exemplary embodiment of FIGS. 2-4 shows two forming tools, one of ordinary skill in the art will know and appreciate that in some situations, it may be preferable to use more than two forming tools, for example, depending on the shape, size, and configuration of the container 200 and/or upper portion 202.

According to an exemplary embodiment of the invention, one or both of the forming tools 207, 208 can be substantially unheated. For example, the forming tools 207, 208 may be kept at room temperature (ignoring the heating effects due to contact with the upper portion 202). Accordingly, when the heated upper portion 202 contacts the forming tools 207, 208, the relatively cool forming tools 207, 208 cause the upper portion 202 to cool and solidify. Thus, compressing the softened upper portion 202 with the relatively cool forming tools 207, 208 reforms, cools, and solidifies the upper portion 202 (e.g., the flange 204), resulting in a reformed upper portion 202 having a smooth surface finish, as well as high geometrical and dimensional tolerances. Air vents, channels, or similar cooling structures can be provided in one or both of the forming tools 207, 208 to help maintain the forming tools 207, 208 at or near room temperature. Additionally or alternatively, coolant can be pumped through channels in one or both of the forming tools 207, 208 to actively cool the forming tools 207, 208 to desired temperature. For example, one of ordinary skill in the art will know and appreciate that a pump can be used to circulate a coolant, such as a water/glycol mixture, through a cooling system and into channels in the forming tools 207, 208, although other configurations are possible and contemplated.

The container of the present invention can be made of monolayer plastic construction, or alternatively, of multilayer plastic construction. In the case of a container of multilayer plastic construction, intermediate layers may or may not extend into the upper portion of the container. For polypropylene, it has been found that the softening temperature is in the range of about 220 to 320° F., preferably about 275 to 315° F., and more preferably about 300° F. According to one exemplary embodiment, the surfaces of the forming tools that contact the upper portion of the container are maintained at a temperature of less than 100° F.

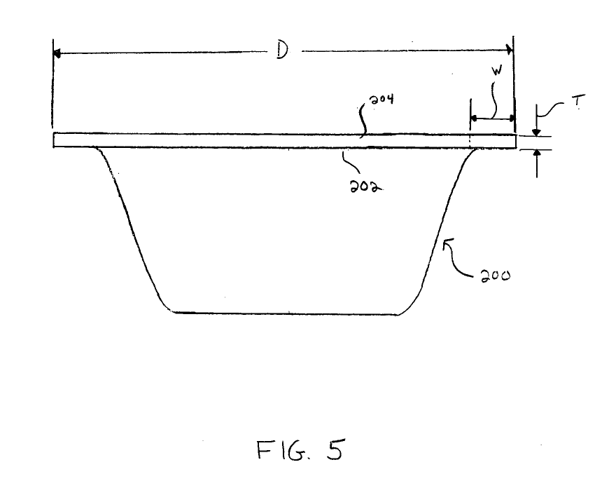

Referring to FIG. 5, a plastic container 200 having an upper portion 202 reformed in accordance with the present invention is shown. As shown in FIG. 5, the upper portion 202 exhibits high geometrical and dimensional tolerances, such as the thickness T, width W, and outer diameter D of the flange 204. The reforming method of the present invention can facilitate use of high-output blow molding processes (e.g., continuous extrusion blow molding) to produce the container, while obtaining the high geometrical and dimensional tolerances for the upper portion 202 typical of lower output processes such as injection blow molding. The reforming method can also facilitate the production of multi-layer containers, due to the robust layer formation associated with the continuous extrusion blow molding process.

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

What is claimed is:

1. A method of reforming an upper portion of a blow molded plastic container, the method comprising the steps of:
(a) directing energy from a non-contact heater onto the upper portion to soften the upper portion; and
(b) compressing the upper portion between at least a first forming tool and a second forming tool to reform the upper portion.

2. The method of claim 1, wherein said step (a) comprises heating the upper portion to about its softening temperature.

3. The method of claim 1, wherein said step (a) comprises leaving remaining portions of the plastic container relatively unheated compared to the upper portion.

4. The method of claim 1, wherein at least one of the first forming tool or the second forming tool is unheated, and said step (c) comprises cooling the upper portion by contacting the upper portion with at least one of the first forming tool or the second forming tool.

5. The method of claim 1, wherein the first forming tool is substantially opposed to the second forming tool.

6. The method of claim 1, wherein the first forming tool and the second forming tool mate to define a cavity in which the upper portion is reformed.

7. The method of claim 6, wherein a portion of the first forming tool contacts a portion of the second forming tool to orient the first and second forming tools with respect to one another.

8. The method of claim 6, wherein the cavity is adapted and configured to reform the upper portion of the plastic container into an outwardly-extending flange.

9. The method of claim 1, wherein the first reforming tool extends around the upper portion of the plastic container.

10. The method of claim 9, wherein the second reforming tool presses the upper portion against the first reforming tool.

11. The method of claim 1, wherein the upper portion is substantially annular.

12. A blow molded plastic container having a upper portion with a flange reformed in accordance with the method set forth in claim 1.

13. An apparatus for reforming an upper portion of a blow molded plastic container, comprising:
a non-contact heat source adapted to heat the upper portion of the plastic container; and
first and second reforming tools spaced apart from the heat source, the first and second reforming tools adapted to compress the heated upper portion between the first and second reforming tools to reform the upper portion.

14. The apparatus of claim 13, wherein the first and second reforming tools are unheated.

15. The apparatus of claim 13, wherein the first and second reforming tools are substantially opposed to one another.

16. The apparatus of claim 13, wherein the first forming tool and the second forming tool mate to define a cavity in which the upper portion is reformed.

17. The apparatus of claim 16, wherein a portion of the first forming tool contacts a portion of the second forming tool to orient the first and second forming tools with respect to one another.

18. The apparatus of claim 16, wherein the cavity is adapted and configured to reform the upper portion of the plastic container into an outwardly-extending flange.

19. The apparatus of claim 16, wherein the first reforming tool is adapted to surround the upper portion of the plastic container.

20. The apparatus of claim 19, wherein the second reforming tool is adapted to press the upper portion against the first reforming tool.
